(19) United States
(12) Patent Application Publication
(10) Pub. No.: US 2013/0286785 A1
(43) Pub. Date: Oct. 31, 2013

(54) METHOD AND APPARATUS FOR INCREASING THE DIRECTION-FINDING ACCURACY OF A RECEIVER ARRANGEMENT

(71) Applicants: Frank Beckefeld, Emtinghausen (DE); Klaus Renken, Syke (DE)

(72) Inventors: Frank Beckefeld, Emtinghausen (DE); Klaus Renken, Syke (DE)

(73) Assignee: ATLAS ELEKTRONIK GMBH, Bremen (DE)

(21) Appl. No.: 13/996,547

(22) PCT Filed: Dec. 23, 2011
(86) PCT No.: PCT/EP11/73959

§ 371 Date: Jul. 15, 2013

(30) Foreign Application Priority Data
Dec. 29, 2010 (DE) 10-2010056528.8

(51) Int. Cl. G01S 3/803

(52) U.S. Cl. CPC G01S 3/803
USPC 367/118

(57) ABSTRACT

A method for increasing a bearing accuracy of a receiver assembly includes providing a receiver assembly which receives sound waves to determine reception signals. The reception signals determine direction signals of a reception direction. Frequency lines of a frequency of a frequency range comprising an amplitude value are attributed to a reception direction based the direction signals. A directional function is formed for each frequency. Each directional function is transformed into a spectral range to obtain a first spectral function comprising first spectral function arguments. The first spectral function are filled with other spectral function arguments between middle spectral function arguments of the first spectral function arguments to obtain filled first spectral arguments. The other spectral function arguments have a respective value of zero or a range of zero. Each of the filled first spectral functions are transformed back from the spectral range to an interpolated first directional function.

### CROSS REFERENCE TO PRIOR APPLICATIONS

This application is a U.S. National Phase application under 35 U.S.C. §371 of International Application No. PCT/EP2011/073959, filed on Dec. 23, 2011 and which claims benefit to German Patent Application No. 10 2010 056 528.8, filed on Dec. 29, 2010. The International Application was published in German on Jul. 5, 2012 as WO 2012/089668 A1 under PCT Article 21(2).

### FIELD

The present invention relates to a method for increasing the bearing accuracy of a receiver assembly as well as a device for increasing the bearing accuracy of a receiver assembly.

### BACKGROUND

The prior art in sonar engineering describes bearings on sound-emitting or sound-reflecting targets which are taken by way of directional patterns. The directional patterns correspond to direction signals of relative reception directions toward a receiver assembly of a sonar unit. To this end, the sound waves of the sound-emitting or sound-reflecting targets are converted into electric signals by the receivers of a reception unit and, based on the electric signals, which are referred to as reception signals, direction signals of a relative reception direction are determined by time-delayed adding.

DE 24 59 219 describes a method and a device for determining a direction where a sonar has a receiver assembly with spatially distributed electro-acoustic converters. The complete opening angle, from which sound waves can be received with the receiver assembly and converted into reception signals, is divided into partial opening angles. For each partial opening angle, a direction signal is formed by delay compensation based on the reception signals.

In order to increase the bearing accuracy of the reception direction, the complete opening angle must be divided into as many partial opening angles of the complete opening angle as possible and for each of these partial opening angles, a direction signal must be calculated separately.

A disadvantage thereof is that the delay compensation, i.e., the addition of the individual delayed reception signals for calculating a direction signal, is very computation-intensive. Increasing the bearing accuracy of the reception direction is therefore only possible with a great computation effort.

### SUMMARY

An aspect of the present invention is to increase the bearing accuracy of the reception directions of a receiver assembly without calculating additional direction signals based on the reception signals.

In an embodiment, the present invention provides a method for increasing a bearing accuracy of a receiver assembly which includes providing a receiver assembly configured to receive sound waves. The receiver assembly and the sound waves received are used to determine reception signals. The reception signals are used to determine direction signals of a reception direction. Frequency lines of a frequency of a frequency range comprising an amplitude value are attributed to a same reception direction based on each of the direction signals. A directional function is formed for each frequency of the frequency range. A first function argument of the directional function corresponds to the reception direction. Adjacent first function arguments correspond to adjacent reception directions. The first function argument comprises, as a function value, the amplitude value or a value of a frequency line of a frequency of the directional function of the reception direction corresponding to the first function argument derived from the amplitude value. Each directional function is transformed into a spectral range so as to obtain a first spectral function comprising first spectral function arguments. The first spectral function are filled with other spectral function arguments between middle spectral function arguments of the first spectral function arguments so as to obtain filled first spectral arguments. The other spectral function arguments have a respective value of zero or in a range of zero. Each of the filled first spectral functions are transformed back from the spectral range so as to result in an interpolated first directional function.

### BRIEF DESCRIPTION OF THE DRAWINGS

The present invention is described in greater detail below on the basis of embodiments and of the drawings in which:

FIG. 1 shows a device according to an embodiment of the present invention for implementing an embodiment of the method according to the present invention;

FIG. 2 shows a more precise representation of a direction generator of the device from FIG. 1;

FIG. 3 shows a more precise representation of a spectral generator of the device from FIG. 1;

FIG. 4 shows a more precise representation of a panorama interpolator of the device from FIG. 1;

FIG. 5a shows a frequency range of an absolute-value spectrum with frequency lines;

FIG. 5b shows a frequency band with a frequency band amplitude value;

FIG. 6 shows a directional function of a frequency;

FIG. 7 shows the directional function from FIG. 6, the function being filled with left-hand side and right-hand side function arguments;

FIG. 8 shows the absolute-value of a first spectral function;

FIG. 9 shows the absolute-value of a first spectral function with filled-in other spectral function arguments;

FIG. 10 shows an interpolated first directional function with left-hand side and right-hand side function arguments; and

FIG. 11 shows an interpolated first directional function.

### DETAILED DESCRIPTION

In an embodiment, the method according to the present invention as well as the device according to the present invention are configured so that frequency lines of other directions are interpolated based on the frequency lines of already-calculated direction signals of a reception assembly attributed to one respective reception direction.

In an embodiment, the present invention relates to a method for increasing the bearing accuracy of a receiver assembly. The method can be implemented, for example, with a sonar unit, for example, on an underwater vehicle or an underwater running body. Sound waves incoming from a complete opening angle are converted into reception signals and from reception signals into direction signals. The direction signals are thereby attributed to one respective reception direction relative to the reception assembly, i.e., to the orientation or position of the reception assembly, and represent the sound waves received from the respective relative reception direction. Based on each direction signal, frequency lines attributed to the same reception direction of the direction signal are determined or calculated by transforming the direction signal into the spectral region, and the absolute-value spectrum is determined or formed by absolute-value generation based on the direction signal transformed into the spectral region. Each of the absolute-value spectrums of a direction signal has frequency lines of one respective frequency of the frequency range of the absolute-value spectrum, which are attributed to the same reception direction of the direction signal from which the absolute-value spectrum has been calculated. Each frequency line of the absolute-value spectrum furthermore has an amplitude value.

Directional functions of one respective frequency with first function arguments are formed. A directional function is thereby separately formed for each frequency of the frequency range. Each directional function has first function arguments with a function value. Adjacent first function arguments of one of the directional functions are formed based on the frequency lines of adjacent reception directions with the same frequency as that for which directional function was formed. As a function value, each function argument comprises the amplitude value or a value of the frequency line of the frequency of the respective directional function of the reception direction corresponding to the respective first function argument, deduced from the amplitude value.

Each of the directional functions is transformed into the spectral region, i.e., from a so-called angular range into a so-called angle frequency range, whereby a first spectral function with first spectral function arguments is obtained from each directional function. Between the middle spectral function arguments of the first spectral function arguments, other spectral function arguments are inserted into the first spectral function, or the first spectral function is filled with other spectral function arguments. The other spectral function arguments respectively have function values of zero or in the range or zero.

The first spectral function filled with further spectral function arguments is converted back from the spectral range, i.e., the so-called angle frequency range into the so-called spectral range, thus resulting in an interpolated first directional function for the frequency for which the directional function on which it is based was formed. This interpolated first directional function comprises interpolated function arguments between the first function arguments. The interpolated function arguments correspond to frequency lines of other relative directions to the receiver assembly with the frequency of the directional function. Each of the other relative directions of respectively one interpolated function argument is thereby located between the reception directions of the first arguments between which the respective interpolated function argument is located. From the interpolated function arguments of the same relative direction of all interpolated first directional function, i.e., for all frequencies of the frequency range, a spectrum, for example, of these relative directions, can be formed.

The present invention furthermore relates to a device for increasing the bearing accuracy of a receiver assembly. The device can, for example, be a component of a sonar unit, for example, of a underwater vehicle or of an underwater running body. The device can be configured so as to receive sound waves with a receiver assembly and to determine reception signals based on the sound waves. Direction signals of one respective reception direction relative to the receiver assembly are formed or determined based on the reception signals and, based on the direction signal, frequency lines are calculated or determined, for example, by a Fourier transform, discrete Fourier transform or fast Fourier transform of the direction signal with subsequent absolute value generation. The frequency lines are attributed to the same reception direction to which the direction signal, based on which the frequency lines were determined, is also attributed. Each frequency line thereby corresponds to a frequency of a frequency range and has an amplitude value.

The device is furthermore configured so as to form respective directional functions for one frequency with first function arguments. The adjacent first function arguments hereby correspond to the frequency lines of the adjacent reception directions with the frequency for which the directional function is formed; i.e., several frequency lines of respectively one of different frequencies of a frequency range are attributed to each reception direction. For forming a directional function, the frequency lines of the reception directions of the same frequency are represented as function arguments of the directional function. A directional function then contains all the frequency lines of the same frequency, namely the frequency of the respective directional function, for all reception directions. Adjacent first function arguments correspond to adjacent reception directions. Each function argument has the amplitude value as a function value or a value of the frequency line of the frequency of the respective directional function of the reception direction corresponding to the first function argument derived from the amplitude value.

The device is moreover configured so as to transform each of the directional functions into the spectral range. After transformation, a first spectral function, which has first spectral function arguments, is obtained based on each directional function. The device is furthermore configured so as to insert or fill in other spectral function arguments between the middle spectral function arguments of the first spectral arguments. The other spectral function arguments are chosen so that they have respective function values of zero or in the range of zero. The device is additionally configured so as to transform the first spectral function filled with other spectral function arguments back from the spectral range, thus resulting in an interpolated first directional function.

The interpolated first directional function has interpolated function arguments between the first function arguments; i.e., the interpolated first directional function corresponds for the most part to the respective directional function on which the calculation is based but has additional interpolated function arguments between the first function arguments. The interpolated function arguments of an interpolated first directional function correspond to the frequency lines of other relative directions.

The advantage of the method according to the present inventions as well as of the device according to the present invention is that by determining interpolated frequency lines of other relative directions, the bearing accuracy of the receiver assembly, for example, a sonar unit, can be increased without having to form other direction signals based on the reception signals. The bearing accuracy is increased since received sound waves or the frequency lines determined from them can not only be attributed to reception signals, but also to other relative directions, thus increasing the resolution of the complete opening angle of the receiver assembly.

In an embodiment of the method according to the present invention, the frequency range, for example, of the absolute-value spectrum of one of the direction signals, is divided into frequency bands. For each frequency band, a frequency band line is then determined based on the amplitude values or based on the values of the frequency lines of the respective frequency band with a frequency band amplitude value, derived from the amplitude values. The directional functions are furthermore formed for respective one frequency band instead of a frequency, based on the frequency band lines of the frequency bands instead of the frequency lines. The directional function is thereby formed based on the frequency band amplitude values for the frequency band of the directional function of all reception directions by representing them as function arguments of the directional function for a frequency band.

In an embodiment of the present invention, the device is configured so as to divide the frequency range into frequency bands of respective one partial frequency range. The device is additionally configured to determine a frequency band line for each frequency band based on the frequency lines of the respective frequency band with a frequency band amplitude value, the frequency band amplitude value being determined by means of mathematical methods such as average calculation or adding based on the amplitude values or on the values of the frequency lines of a frequency band of the respective frequency band amplitude value, derived from the amplitude values. The device is furthermore configured so as to form the directional functions for a frequency range based on the frequency band amplitude values by forming the first function arguments based on the frequency band amplitude values of the frequency band of the directional function of all reception directions. Each directional function is thus formed for a frequency band and the function arguments of the directional function are represented by frequency band amplitude values, the directional function being respectively formed by the frequency band amplitude values of the same frequency band of all the reception directions.

The advantage of forming directional frequencies from frequency bands and frequency band amplitude values instead of frequencies and amplitude values or values derived from the amplitude values is that less directional functions need to be formed for calculating interpolated frequency band amplitude values of other relative directions in order to cover the entire frequency range, thus allowing for faster computation with less energy expenditure. This is advantageous when a more precise resolution of the directions of the complete angle aperture is preferred to a more precise resolution of the frequency range.

In an embodiment of the present invention, the reception signals for determining the direction signals are submitted to frequency conversion into a lower band or a lower frequency range. The frequency-converted reception signals are then low-pass filtered and the low-pass filtered frequency-converted reception signals are digitized. Direction signals are furthermore determined or calculated based on the digitized low-pass filtered frequency-converted reception signals, for example, by delayed i.e., time-compensated adding.

In an embodiment of the device according to the present invention, the device is configured so as to frequency-convert the reception signals for determining the direction signals into a lower frequency range. The device is furthermore configured so as to low-pass filter the frequency-converted reception signals and to digitize the low-pass filtered frequency-converted reception signals. The device is moreover configured so as to form direction signals based on the digitized low-pass filtered frequency-converted reception signals.

The advantage of the frequency conversion of the reception signals is that digitization with a low sampling frequency is possible based on the Nyquist-Shannon sampling theorem, whereby comparatively lesser amounts of data have to be processed and/or a lower computation effort is required in case of downstream digitization.

The advantage of low-pass filtering is that only the essential information of the frequency-converted reception signals are preserved after low-pass filtering. Due to the frequency-conversion, sum mixing products are formed, for example, which contain information that is unessential for further processing. By removing this unessential information, a lower computation effort is required for further processing.

The advantage of digitization of the low-pass filtered frequency-converted reception signals is that further signal processing after digitization can be carried out digitally, so that again a lower computation effort is required for further digital procession as compared to analog processing.

In an embodiment of the method according to the present invention, each directional function is transformed into the spectral range with a complex discrete Fourier transform and transformed back from the spectral range with an inverse complex discrete Fourier transform.

In an embodiment of the device according to the present invention, the device is configured so as to transform each of the directional functions into the spectral range with a complex discrete Fourier transform and to transform it back from the spectral range with an inverse complex discrete Fourier transform.

The advantage of the transformation of the directional functions with a complex discrete Fourier transform and/or of the reverse transformation with an inverse complex discrete Fourier transform is that it requires only a low computation effort as compared, for example, to a normal Fourier transform. Computation effort can thus be saved and the time needed for the transformation and for the reverse transformation can be reduced.

In an embodiment of the present invention, each of the directional functions are filled with left-hand and right-hand side function arguments, the left-hand side function arguments corresponding to directions which lie to the left of the angles of the reception directions of the first function arguments. The right-hand side function arguments furthermore correspond to directions, which lie to the right of the reception directions of the first function arguments. Left-hand side function arguments and right-hand side function arguments thus correspond to directions that lie outside of the complete opening angle of the receiver assembly. A representation of this is that starting from a null angle, formed, for example, by one of the reception directions, in a clockwise or right-hand rotation, some reception directions lie within the complete opening angle on the right-hand side of null angle and thus correspond to first function arguments. On the other hand, other directions lie on the right hand side or in the clockwise direction outside of the complete opening angle of the receiver assembly, which then corresponds to the right-hand side function arguments. Left-hand side function arguments correspondingly lie on the left-hand side, i.e., in the counter-clockwise direction starting from a zero value, next to the complete opening angle of the receiver assembly.

The left-hand side function arguments are inserted and/or filled-in below or on the left-hand side of the function argument of the first function arguments that corresponds to the far left-hand side reception direction of the complete opening angle, and the right-hand side function arguments are inserted or filled-in above or on the right-hand side of the function argument of the first function arguments that corresponds to the far right-hand side reception direction of the complete opening angle. Just as many smaller and bigger function arguments as compared to the first function arguments are filled into the directional function, so that the total amount of the function arguments correspond to a power of two.

In an embodiment of the device according to the present invention, the device is configured so as to fill-in each of the directional functions with left-hand side and right-hand side function arguments. The left-hand side function arguments hereby correspond to directions lying to the left of reception directions and the right-hand side function arguments to directions lying to the right of reception directions. The device is furthermore configured so as to fill-in the left-hand side function arguments on the left-hand side of or below the function argument of the first function arguments that corresponds to the far left-hand side reception direction of the complete opening angle and to fill-in the right-hand side function arguments on the right-hand side of or above the function argument of the first function arguments that corresponds to the far right-hand side reception direction of the complete opening angle. The device is configured so as to insert or fill-in just as many smaller and bigger function arguments as compared to the first function arguments into the directional function, so that the total amount of the function arguments correspond to a power of two.

The advantage of adding or filling the directional functions with left-hand side and right-hand side function arguments is that the directional functions can respectively be transformed in to the spectral range with a complex Fast Fourier Transform (FFT), whereby further computation efforts are saved and a faster computation with a lesser energy expenditure is possible as compared to a transformation with a complex discrete Fourier transform.

In an embodiment of the method according to the present inventions, the function value of the far left function argument of the left-hand side function arguments, i.e., the function argument that corresponds to the far left direction, has a value of zero or in the range of zero. The function value of the far right function argument of the right-hand side function arguments, i.e., the function argument that corresponds to the far right direction, also has a value of zero or in the range of zero.

In an embodiment of the device according to the present invention, the device is configured so as to choose the function value of the far left function argument of the left-hand side function arguments so that it has a value of zero or in the range of zero. The device is furthermore configured so as to choose the function value of the far right function argument of the right-hand side function arguments so that it has a value of zero or in the range of zero.

The advantage of function values of the far left function argument of the left-hand side function arguments and of the far right function argument of the right-hand side function arguments of zero or in the range of zero is that during spectral transformation of the directional functions by Fourier transformation, so-called “spectral leakage” can mostly be avoided.

In an embodiment of the method according to the present invention, the gradient of the function values of the first function arguments is first continued through the function values of the left-hand side function arguments in the range of the far left function arguments of the first function arguments that corresponds to the far left reception direction, before the function values of the left hand function arguments up to the function argument of the left-hand side function argument that corresponds to the far left direction adjacent to the reception directions, fall to a value of zero or in the range of zero. The gradient of the function values of the first function arguments is furthermore first continued through the function values of the right-hand side function arguments in the range of the function argument of the first function arguments that corresponds to the far right reception direction, before the function values of the right-hand side function arguments up to the function argument of the right-hand side function arguments that corresponds to the far right direction adjacent to the reception directions, fall to a value of zero or in the range of zero. The gradient of the function values of the first function arguments is thus considered in the marginal areas of the first function arguments respectively to the left-hand side and the right-hand side function arguments and respectively continued with the same increase through the function values of the left-hand side and right-hand side function arguments in the respective marginal area.

The advantage of a continued increase of the function values of the first function arguments of a directional function in the marginal areas is that a more precise interpolation of the frequency lines of the reception directions in the marginal areas of the receiver assembly, i.e., in the marginal areas of the complete opening angle, are thus made possible.

In an embodiment, one respective second spectral function identical to the first spectral function is multiplied with the function variable or the negative function variable and filled with other spectral function arguments in the same way as the respective first spectral function. In other words, second spectral function is generated for each of the first spectral functions. This second spectral function corresponds, so to speak, to a copy of the first spectral function. The second spectral function is then multiplied with the function variable or the negative function variable of the spectral angular range function. The function variable hereby corresponds to the transformed variable of the directional function multiplied with the imaginary unit “i”, i.e., \sqrt{−1}. The second spectral function is furthermore filled with other spectral function arguments between the middle spectral function arguments of the first spectral arguments in the same way as the respective first spectral function. Finally, each of the filled second spectral functions is transformed back from the spectral range, thus resulting in an interpolated second directional function. The interpolated second directional function thereby corresponds to the derived interpolated first directional function.

The advantage of forming the derivative of the first interpolated directional function by multiplication in the spectral range is that maxima of the interpolated first angular range function can be easily determined, whereby frequency lines with high amplitude values are recognized.

In an embodiment of the method according to the present invention, each of the interpolated first directional functions is filled with additional other function arguments with interpolated function values by linear interpolation. Additional other function arguments, which have an interpolated function value that respectively corresponds, for example, to the average of the function arguments adjacent to the additional other function argument, are thus inserted between the first function arguments and the interpolated function arguments.

The advantage of linear interpolation is that frequency lines of other interpolated reception directions can be generated with little computation effort.

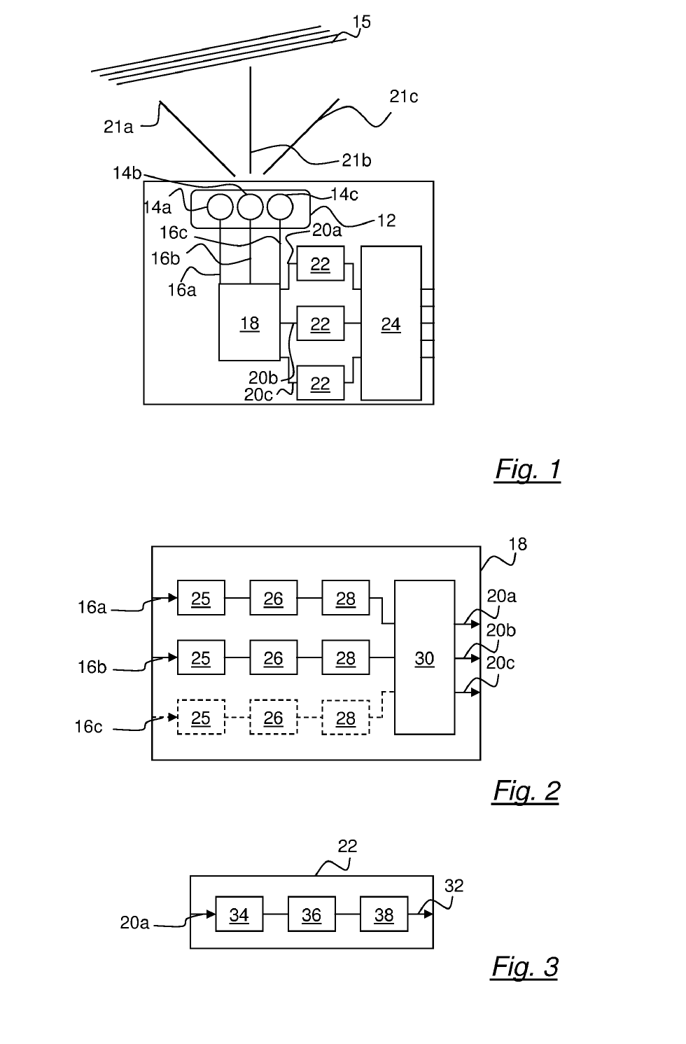

FIG. 1 shows an embodiment of the device according to the present invention, for example, of a sonar unit, for example, on an underwater vehicle or an underwater body, with a receiver assembly 12, consisting of several receivers 14a to 14c for receiving incoming sound waves 15. The receivers 14a to 14c are, for example, electro-acoustic and/or opto-acoustic receivers and/or converters or hydrophones. The received sound waves 15 are converted into reception signals 16a to 16c with the receivers 14a to 14c. These reception signals 16a to 16c are fed to a direction generator 18 that generates direction signals 20a to 20c based thereon. Each of the direction signals 20a to 20c corresponds to one respective reception direction 21a to 21c relative to the receiver assembly 12.

The reception directions 21a to 21c correspond to one respective angle relative to the receiver assembly 12. As an example, it is advantageous to determine one of the reception directions 21a to 21c as a reference angle or null angle. In FIG. 1, the reception direction 21b is determined as a null angle, since it is centered in the complete opening angle perpendicular to the receiver assembly 12. The reception direction 21a then lies on the left-hand side and the reception direction 21b lies on the right-hand side of the null angle, respectively, of the reception direction 21c.

The direction signals 20a to 20c are respectively fed to one spectrum generator 22 that respectively determines a frequency spectrum as well as its absolute-value spectrum based on one of the direction signals 20a to 20c. Each absolute-value spectrum determined in a spectrum generator 22 is fed to a panorama interpolator 24 that is connected downstream of the spectral generator 22.

In the panorama interpolator 24, other absolute-value spectrums of other relative directions are formed based on the frequency lines of the absolute-value spectrums of the direction signals 20a to 20c of a reception direction 21a to 21c. The frequency lines of the reception directions 21a to 21c and of other interpolated frequency lines of other relative directions are output at the output of the panorama interpolator 24.

FIG. 2 shows a more precise representation of the direction generator 18 from FIG. 1. The reception signals 16a to 16c are supplied to the direction generator 18, each of the reception signals 16a to 16c being supplied to one respective frequency converter 25. In the frequency converter 25, which is, for example, a quadrature mixer, the reception signals 16a to 16c are frequency-converted into lower frequency range and/or are mixed into a lower frequency range. Each of the frequency-converted reception signals is subsequently supplied to a low-pass filter 26 to remove the unessential frequency parts that were generated, for example, during frequency conversion.

Each of the frequency-converted low-pass filtered reception signals is supplied to an analog-to-digital converter 28 that is connected downstream of the low-pass filter 26. The analog-to-digital converter 28 digitizes the frequency-converted low-pass filtered reception signal with a sampling rate that can be chosen freely, but must take account of the Nyquist-Shannon sampling theorem. The frequency-converted low-pass filtered digitized reception signals are then supplied to a delay adding unit 30.

A run time compensation of the frequency-converted low-pass filtered digitally transformed reception signals is carried out in the delay adding unit 30 in order to output the direction signals 20a to 20c of one respective reception direction 21a to 21c at the output of the delay adding unit 30.

In FIG. 2 shows a delay adding unit 30, however, it would also be possible to determine direction signals with a phase delay adding unit. Instead of compensating for the runtime of the reception signals 16a to 16c in the same way as in a delay adding unit 30, i.e., adding the reception signals 16a to 16c with a delay, the phase of each frequency-converted low-pass filtered digitized reception signal 16a to 16c would be shifted in a determined manner and these reception signals would then be added in order to form the direction signals 21a to 21c.

FIG. 3 shows the spectral generator 22 from FIG. 1. A direction signal 20a of the direction signals 20a to 20c is supplied to the spectral generator 22 and an absolute-value spectrum 32 of the same reception directions 21a to 21c of the direction signal is determined based thereon.

The direction signal 20a of the direction signals 20a to 20c is first supplied to a frame generator 34. A time frame of a defined time period is cut out of the direction signal 20a in the frame generator 34. This time frame, i.e., the time section of the direction signal 20a is supplied to a DFT unit 36 connected downstream of the frame generator 34. In the DFT unit 36, a frequency spectrum of the time period of the direction signal 20a is determined based on the time section of the direction signal 20a by means, for example, of a discrete Fourier transform or a fast Fourier transform. The frequency spectrum is supplied to an absolute-value generator 38 that is connected downstream of the DFT unit 36 and an absolute-value spectrum 32 is determined by absolute-value generation of the frequency spectrum. The absolute-value 32 is output at the output of the spectral generator 22.

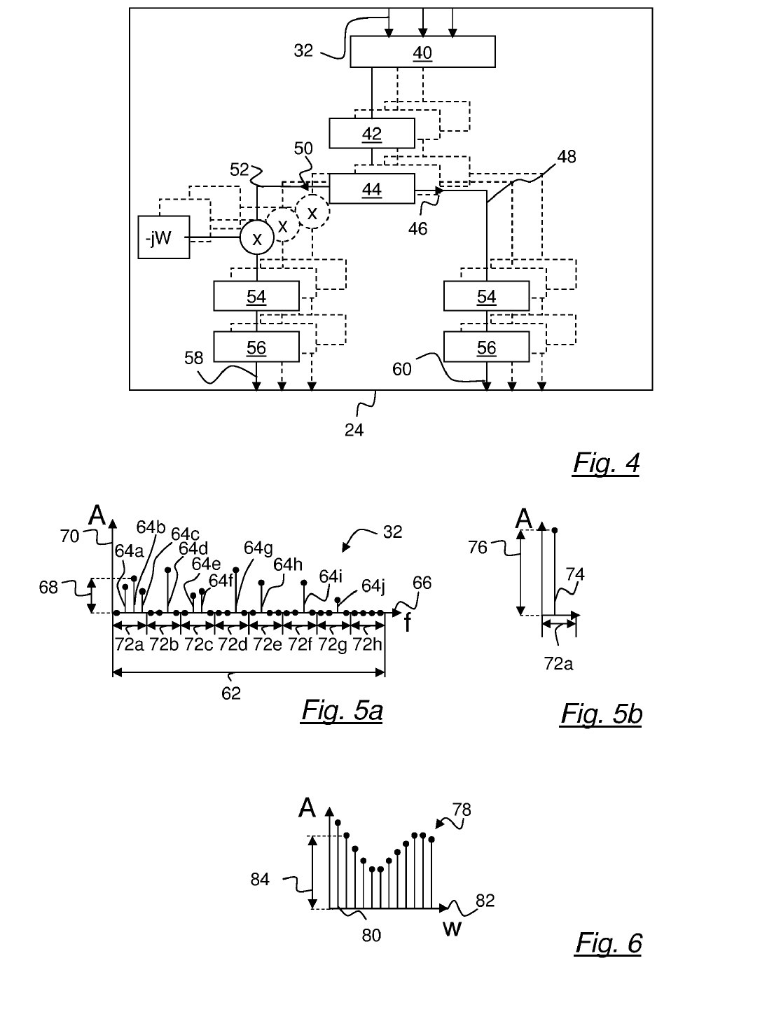

FIG. 4 shows the panorama interpolator 24 from FIG. 1. The absolute-value spectrums 32 of each direction signal 20a to 20c of a reception direction 21a to 21c are supplied to the panorama interpolator 24. Each absolute-value spectrum 32 has frequency lines that, respectively, correspond to a frequency of the frequency range of the absolute-value spectrum and have an amplitude value, which is a measure for the intensity of the frequency of the respective frequency line that comes in from the reception direction 21a to 21c attributed to the absolute-value spectrum 32 onto the reception assembly 12 in the form of sound waves 15. The frequency lines are first supplied to a directional function generator 40 in the panorama interpolator 24. In the directional function generator 40, the directional functions for one respective frequency of the frequency lines of a frequency of the frequency range are generated, whereby each directional function has first function arguments. The first function arguments of a directional function are generated based on the frequency lines of the same frequency of all amplitude-value spectrums 32 attributed to one respective reception direction 21a to 21c. Adjacent first function arguments correspond to the frequency lines of adjacent reception directions 21a to 21c.

For each frequency of the frequency range of the absolute-value spectrum 32, a single directional function is generated in the directional function generator 40. The following steps can hereby be carried out in parallel for individual directional functions in parallel processing paths or consecutively in the same processing path.

Each of the directional functions determined in the directional function generator 40 is supplied to a filling unit 42. In the filling unit 42, left-hand side function arguments and right-hand side function arguments are added to the first function arguments. The directional function is thus filled by the left-hand side function arguments as well as the right-hand-side arguments. Since each function argument corresponds to a directional function of different reception directions, the designation left-hand side function arguments or right-hand side function arguments is chosen to describe function arguments that correspond to imaginary directions relative to the receiver assembly 12 that lie next to the reception directions in the counter-clockwise direction, i.e., on the left-hand side, or in the clockwise direction, i.e., on the right-hand side. Filling results in a filled directional function that is supplied to a second DFT-unit 44 connected downstream of the filling unit 42.

The filled directional function supplied to the second DFT-unit 44 is transformed into a first spectral function. The identification of the directional function that is transformed from the angular range into the angle frequency range can be chosen in a similar way as for the identification of a temporal function that is transformed from the time domain into the frequency domain. The filled directional function is thus transformed spectrally, e.g., with a complex discrete Fourier transform.

The first spectral function 46 generated in the second DFT-unit 44 is attributed to a first processing path 48 and the same first spectral function 46 is attributed as a second spectral function 50 to a second processing path 52. In the second processing path 52, via which the spectral function arguments are plotted, the second spectral function 50 is multiplied with the function variable jW consisting of the imaginary unit, mostly designated “j” or “i”, and the angle frequency, e.g., W. A multiplication with the negative function variable −jW is also possible.

After multiplication, the multiplied second spectral function 50 is supplied to a zero filler 54, which adds further function arguments between the middle spectral function arguments of the first spectral function arguments of the second spectral function 50, i.e., fills the second spectral function 50 with other spectral function arguments. The further spectral function arguments have function values of zero or in the range of zero. After having been filled with further spectral function arguments, the filled multiplied second spectral function 50 is supplied to an IDFT-unit 56. In the IDFT-unit 56, the filled multiplied second spectral function 50 is transformed back from the spectral range, according to the above identification chosen, in a similar way as for a time function, from the angle frequency range “W” into the angular range “w”, for example, with a complex inverse discrete Fourier transform. An interpolated second directional function 58 is formed at the output of the second processing path 52.

In the first processing path 48, the first spectral function 46 is filled with other spectral function arguments in a null filler 54 in the same way as the second spectral function and then supplied to an IDFT-unit 56. After reverse transformation of the filled first spectral function, an interpolated first directional function 60 is formed at the output of the IDFT-unit 56 of the first processing path 48.

The interpolated directional functions contain interpolated function arguments between their first left-hand side and right-hand side function arguments. These interpolated function arguments correspond to frequency lines of the frequency of the respective directional function of interpolated other directions. The interpolated function arguments of all generated directional functions of the same direction can now be represented respectively in an absolute-value spectrum that corresponds to an interpolated absolute-value spectrum of an interpolated other direction.

FIG. 5a shows the absolute-value spectrum 32 attributed to one of the relative directions 21a to 21c, which is generated at the output of the spectrum generator 22. The absolute-value spectrum 32 is obtained, for example, from a time frame of one of the direction signals 20a to 20c when this time frame is supplied to a DFT-unit 36 and the absolute-value is calculated with the absolute-value generator 38. The absolute-value spectrum 32 comprises a frequency range 62. Each of the frequency lines 64a to 64j occurring within the frequency range 62 corresponds to one of the function arguments, i.e., to a frequency of the absolute-value spectrum on a frequency axis 66 and has, as a function value, an amplitude value 68 greater than zero. Here and in the following, an amplitude value 68 is used. It is also, however, possible to implement the further method with values derived from the amplitude values. Values derived from the amplitude values are values obtained, for example, by using mathematical methods such as the logarithm function and/or by adding and/or multiplication by a constant. The amplitude values 68 can thereby be read off the amplitude axis 70. The frequency range 62 of the amplitude-value spectrum 32 is divided into adjacent frequency bands 72a to 72h of a partial frequency range by dividing the frequency range 62 of the amplitude-value spectrum 32.

FIG. 5b shows one of the frequency bands 72a to 72h from FIG. 5b, said frequency band now having only one frequency band line 74 instead of several function arguments with function values, i.e., frequency lines 64a to 64j with amplitude values 68. The frequency band line 74 has hereby combined by adding the amplitude value 68, respectively the function values of the frequency lines 64a to 64j and/or function arguments occurring inside one of the frequency bands 72a to 72h. The frequency band line 74 is attributed to the same reception direction 21a to 21c to which the direction signal 20a, based on which the amplitude-value spectrum 32 was determined, is also attributed. The frequency band line 74 corresponds to the frequencies of the respective frequency band 72a to 72h and has a frequency band amplitude value 76 that corresponds to the amplitude values of the frequency lines 64a to 64j of one of the frequency bands 72a to 72h combined, for example, by adding or other mathematical methods.

FIG. 6 shows a directional function 78 that is formed based on the frequency lines 64a to 64j or the frequency band lines 74 of the same frequency or the same frequency band 72a to 72h of different reception directions 21a to 21c. Each frequency line 64a to 64j or frequency band line 74 corresponds to one of the first function arguments 82 on a first axis 80 and has a function value 84, the different reception directions 21a to 21c being plotted on the first axis 80. The axis is here exemplarily labeled “w” for “Winkel” (angle) of the reception direction. In accordance with the designation of a temporal function in a frequency range, the represented function can thus be designated as a directional function in an angle range.

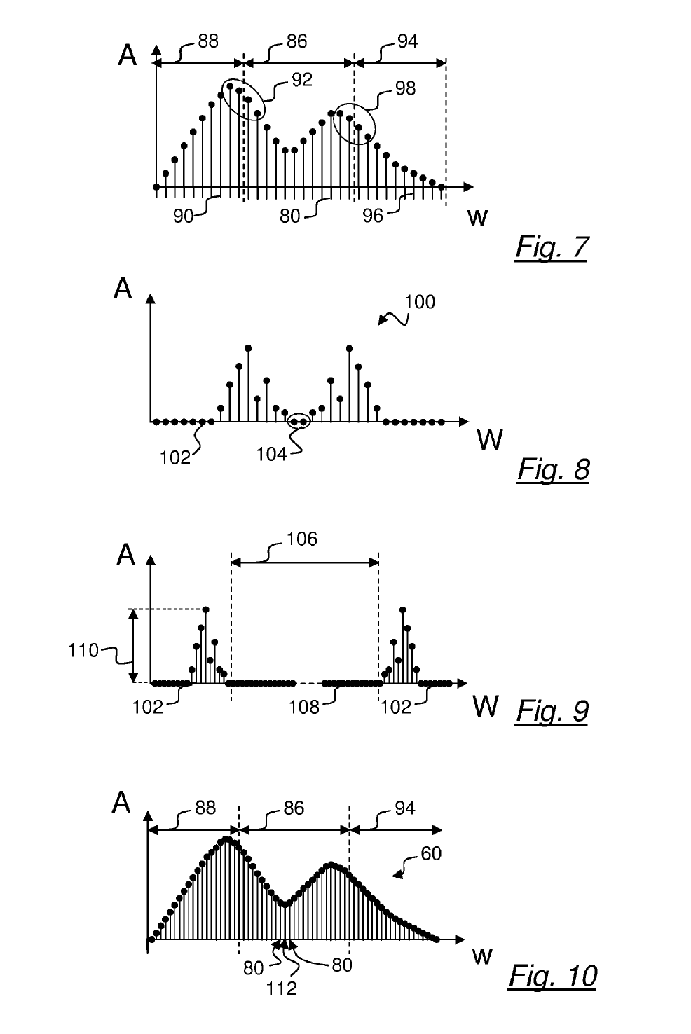

FIG. 7 shows a middle section 86 of the directional function 78 from FIG. 6. On the left-hand side of the middle section 86, left-hand side function arguments 90 have been added in a left-hand side section 88 below the first function arguments 64. In the area 92 of the far left function argument of the first function arguments 80, the gradient of the first function arguments 80 is first continued through the left-hand side function arguments before the left-hand side function arguments 90 up to the far left function argument of the left-hand side function arguments fall to a value of zero or in the range of zero, i.e., have a function value 84 of zero or in the range of zero.

On the right-hand side of the middle section 86 in a right-hand side section 94, the directional function from FIG. 6 has been filled with right-hand side function arguments 96. In the area 98 of the far right of the first function arguments 80, the right-hand side function arguments 96 continue the gradient of the first function arguments, before the far right function argument of the right-hand side function arguments 96 falls to a value of zero or in the range of zero.

FIG. 8 shows the real part 100 of a first spectral function 46, which is generated, for example, with a Fourier transform of a directional function 78 as shown in FIG. 6 from the angle range “w” into an angular frequency range “W”. The shown real part 100 has first spectral function arguments 102 and is symmetrical to the middle spectral function arguments 104 of the first spectral function arguments 102, since directional function 78 on which the generation is based is real-valued.

FIG. 9 shows a filled real part 100 of a first spectral function 46 that has been filled in a middle section 106 with other spectral function arguments 108 between the middle spectral function arguments 104 of the first spectral function arguments 102. The other spectral function arguments 108 in the middle section 106 have a respective function value 110 in the range of zero, here equal to zero.

FIG. 10 shows an interpolated first directional function 60 that has been generated by reverse transformation of a filled first spectral function 46. This interpolated first directional function 60 resembles the directional function 78 from FIG. 6, the interpolated first directional function 60 from FIG. 10 having interpolated function arguments 112 between the first left-hand side and right-hand side function arguments. These interpolated function arguments 112 correspond to interpolated other relative directions that lie between the reception directions 21a to 21c and/or the directions of the corresponding first function arguments 80, left-hand side function arguments 90, and right-hand side function arguments 96.

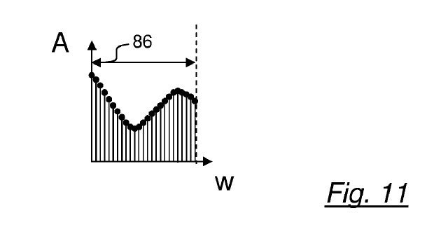

FIG. 11 shows the middle section 86 from FIG. 10 of the interpolated first directional function 60 that is obtained after removing the left-hand side section 88 as well as the right-hand side section 94, for example, simply by masking. Only the first function arguments 80 and the interpolated function values 112 are now shown, the corresponding reception direction 21a to 21c of which, or interpolated other relative direction lies in the range of the complete opening angle of the receiver assembly 12.

Such an interpolated first directional function 60 can now be determined for each frequency line 64a to 64j or frequency of the frequency range 62. This results in interpolated function arguments 112 for each frequency of an interpolated direction. Based on these interpolated function arguments of the same interpolated direction, absolute-value spectrums 32 of one respective interpolated direction can then be formed.

The method according to the present invention and/or the device according to the present invention as well as their embodiments can be used in the field of underwater vehicles or underwater running bodies. A sonar unit of the underwater vehicle or underwater running body is hereby complemented by the device according to the present invention or designed in such a manner that the sonar unit can carry out the method according to the present invention.

All features mentioned in the aforementioned description of the figures, in the claims and in the introduction to the description can be used individually, as well as in any combination with each other. The disclosure of the present invention is therefore not limited to the described or claimed feature combinations. All feature combinations are in fact to be considered as disclosed.

What is claimed is:

1-15. (canceled)

16. A method for increasing a bearing accuracy of a receiver assembly, the method comprising:
providing a receiver assembly configured to receive sound waves;
using the receiver assembly and the sound waves received to determine reception signals;
using the reception signals to determine direction signals of a reception direction;
attributing frequency lines of a frequency of a frequency range comprising an amplitude value to a same reception direction based on each of the direction signals;
forming a directional function for each frequency of the frequency range, wherein,
a first function argument of the directional function corresponds to the reception direction,
adjacent first function arguments correspond to adjacent reception directions, and
the first function argument comprises, as a function value, the amplitude value or a value of a frequency line of a frequency of the directional function of the reception direction corresponding to the first function argument derived from the amplitude value;
transforming each directional function into a spectral range so as to obtain a first spectral function comprising first spectral function arguments, the first spectral function being filled with other spectral function arguments between middle spectral function arguments of the first spectral function arguments so as to obtain filled first spectral arguments, the other spectral function arguments having a respective value of zero or in a range of zero; and
transforming each of the filled first spectral functions back from the spectral range so as to result in an interpolated first directional function.

17. The method as recited in claim 16, wherein,
the frequency range is divided into frequency bands,
the frequency lines for each of the frequency bands are combined to one respective frequency band line,
the frequency band lines comprise one respective frequency band amplitude value combined from the amplitude values or from the values of the frequency lines of the respective frequency band derived from the amplitude values,
one respective directional function is formed for each frequency band of the frequency range, and
each first function argument of the directional function corresponds to one respective reception direction, and each first function argument has, as the function value, the frequency band amplitude value of the frequency band line of the frequency band of the respective directional function of the reception direction that corresponds to the first function argument.

18. The method as recited in claim 16, wherein, in order to determine the direction signals, the method further comprises:
frequency-converting the reception signals into a lower band so as to obtain frequency-converted reception signals;
low-pass filtering the frequency-converted reception signals so as to obtain low-pass filtered frequency-converted reception signals;
digitalizing the low-pass filtered frequency-converted reception signals so as to obtain digitalized low-pass filtered frequency-converted reception signals; and
determining the direction signals based on the digitized low-pass filtered frequency-converted reception signals.

19. The method as recited in claim 18, wherein the determining of the direction signals based on the digitized low-pass filtered frequency-converted reception signals is performed by at least one of by a run-time compensation and by adding.

20. The method as recited in claim 16, wherein the transforming each directional function into the spectral range is performed via a complex discrete Fourier transform, and the transforming of the first spectral functions back from the spectral range is performed with an inverse complex discrete Fourier transform.

21. The method as recited in claim 16, further comprising:
adding left-hand side function arguments that correspond to directions located on a left-hand side of the reception directions, and right-hand side function arguments that correspond to directions located on a right-hand side of the reception directions to each of the directional functions,
adding the left-hand side function arguments on the left-hand side below the first function argument that corresponds to a far left reception direction, and adding the right-hand side function arguments on the right-hand side above the first function argument that corresponds to a far right reception direction, so that a number of all function arguments of a directions function corresponds to a power of two.

22. The method as recited in claim 21, further comprising:
choosing function values of the left-hand side function argument that correspond to a far left direction and choosing function values of the right-hand side function argument that correspond to a far right direction so as to be in a range of zero or equal to zero.

23. The method as recited in claim 22, further comprising:
continuing a gradient of function values of the first function arguments through the function values of the left-hand side function arguments in an area of the first function argument that corresponds to the far left reception direction, and
continuing a gradient of function values of the first function arguments through the function values of the right-hand side function arguments in an area of the first function arguments that corresponds to the far right reception direction.

24. The method as recited in claim 16, further comprising:
multiplying a second spectral function identical to the first spectral function with a function variable (jW) or a negative function variable (−jW) of the spectral functions;
filling the second spectral function with other spectral function arguments as is the respective first spectral function; and
transforming the second spectral function back into an interpolated second directional function.

25. The method as recited in claim 16, further comprising:
filling interpolated first directional functions via a linear interpolation with additional other function arguments with interpolated function values.

26. A device for increasing a bearing accuracy of a receiver assembly, the device comprising a receive assembly and being configured to:
receive sound waves with the receiver assembly;
to determine reception signals based on the sound waves via the receiver assembly;
to determine direction signals of a reception direction based on the reception signals; and
to determine frequency lines of a frequency of a frequency range with an amplitude value attributed to a same reception direction based on each direction signal,
wherein, the device is configured:
to form a directional function for each frequency of the frequency range, wherein
a first function argument of a directional function corresponds to the reception direction,
adjacent first function arguments correspond to adjacent reception directions, and
the first function argument comprises, as a function value, an amplitude value or a value of a frequency line of the frequency of the directional function of a reception direction corresponding to the first function argument derived from the amplitude value;
to transform each of the directional functions into the spectral range, wherein, the first spectral function thereby obtained comprises first spectral function arguments,
to fill a first spectral function with other spectral function arguments between middle spectral function arguments of the first spectral function arguments, wherein the other spectral function arguments comprise a function value of zero or in the range of zero; and
to transform the filled first spectral function back from the spectral range so as to provide an interpolated first directional function.

27. The device as recited in claim 26, wherein the device is further configured:
to divide the frequency range into frequency bands,
to combine the frequency lines for each respective frequency band into a frequency band line, wherein the frequency band lines have one respective frequency band amplitude value combined from the amplitude values or from the values of the frequency lines of the respective frequency band derived from the amplitude values, and
to form one respective directional function for each frequency band of the frequency range, wherein each first function argument of a directional function corresponds to one of the reception directions of the direction signals, and each first function argument has, as a function value, the frequency band amplitude value of the frequency band line of the frequency band of the respective directional function of the reception direction that corresponds to the first function argument.

28. The device as recited in claim 26, wherein the device is further configured to:
frequency-convert the reception signals to a lower band so as to provide frequency-converted reception signals for determining the direction signals,
to low-pass filter the frequency-converted reception signals so as to provide low-pass filtered, frequency-converted reception signals, and
to digitize the low-pass filtered, frequency-converted reception signals so as to provide digitized, low-pass filtered, frequency-converted reception signals, and
to determine direction signals based on the digitized, low-pass filtered, frequency-converted reception signals.

29. The device as recited in claim 28, wherein the determining of the direction signals based on the digitized low-pass filtered frequency-converted reception signals is performed by at least one of by a run-time compensation and by adding.

30. The device as recited in claims 26, wherein the device is further configured:
to transform the directional functions into the spectral range using a complex discrete Fourier transform, and
to transform the first spectral functions back from the spectral range using an inverse complex discrete Fourier transform.

31. The device as recited in claim 26, wherein the device is further configured:
to add left-hand side function arguments which correspond to directions located on a left-hand side of the reception directions, and to add right-hand side function arguments which correspond to directions located on a right-hand side of the reception direction, into each of the directional functions, wherein the left-hand side function arguments are added on a left-hand side below the first function argument that corresponds to a far left reception direction, and the right-hand side function arguments are added on a right-hand side above the first function argument that corresponds to a far right reception direction, so that a number of all function arguments of a directional function corresponds to a power of two.

32. The device as recited in claim 31, wherein the device is further configured:
to choose a function value of the left-hand side function argument that corresponds to a furthest left-hand side direction, and of the right-hand side function argument that corresponds to a furthest right-hand side direction so that these values are in the range of zero or equal to zero.
